(19) United States
(12) Patent Application Publication
(10) Pub. No.: US 2011/0252327 A1
(43) Pub. Date: Oct. 13, 2011

(54) METHODS, SYSTEMS, AND USER INTERFACES FOR GRAPHICAL SUMMARIES OF NETWORK ACTIVITIES

(75) Inventors: Ashish Awasthi, Bangalore (IN); Kailash Ambwani, Menlo Park, CA (US); Tina Joiner, McKinney, TX (US); Pramod D'Souza, Bangalore (IN)

(73) Assignee: Actiance, Inc., Belmont, CA (US)

(21) Appl. No.: 12/942,892

(22) Filed: Nov. 9, 2010

Related U.S. Application Data
(63) Continuation of application No. 12/748,163, filed on Mar. 26, 2010, now abandoned.

(51) Int. Cl. G06F 3/048; G06F 15/16

(52) U.S. Cl. 715/736

(57) ABSTRACT

In various embodiments, techniques are provided for creating visualizations of network traffic. Such disclosed techniques may be incorporated by or implemented by one or more computing devices, computer systems, embedded systems, application-specific circuitry, or the like, that generate visualizations of network traffic. Network traffic information may be obtained in response to monitoring network traffic associated with a communications network. The network traffic information may include a variety of detailed or summary analysis of network traffic. In general, network traffic may summarized according to applications associated with network traffic. Hierarchies developed based on relationships between application categories, the applications themselves, and users or groups associated with the applications may be used to develop one or more of a variety of visual representations of the network traffic information.

### CROSS REFERENCES TO RELATED APPLICATIONS

This application is a continuation of U.S. patent application Ser. No. 12/748,163 filed Mar. 26, 2010 and entitled “Methods, Systems, And User Interfaces For Graphical Summaries Of Network Activities,” which is hereby incorporated by reference for all purposes.

This application is related to the following commonly owned copending applications which are hereby incorporated by reference for all purposes:

U.S. patent application Ser. No. 12/511,713, filed Jul. 29, 2009 and entitled “Management Capabilities for Real-Time Messaging Networks;”
U.S. patent application Ser. No. 12/259,151, filed Oct. 27, 2008 and entitled “Categorizing, Classifying, and Identifying Network Flows Using Network and Host Components;” and
U.S. patent application Ser. No. 12/568,073, filed Sep. 28, 2009 and entitled “Application Detection Architecture and Techniques.”

### BACKGROUND OF THE INVENTION

This application relates to the field of computer networks, and specifically to software and hardware for creating graphical summaries of network activities.

With the advent of modern computers and computer networks, users have been provided with a faster electronic means of communicating with each other. Browser applications, such as Internet Explorer from Microsoft Corporation and Firefox from the Mozilla Foundation, can allow users to browse the world-wide web, obtain news information, share photos or music, or the like, through computer networks, such as the Internet. In another example, e-mail and instant messaging can allow users to interact, for example, in real-time communications.

Computer networks can often include hundreds or thousands of network hosts. A network host can be a computer or other hardware device that runs software applications and originates and/or receives network flows. Network administrators may often be responsible for maintaining these network hosts in proper running order. The network administrators may incorporate a variety of methodologies and devices in an attempt to ensure the network operates securely and reliably. To that end, network administrators may often set rules or network policies for users, groups, and devices about the types of software applications and network traffic allowed on a network.

Network applications may include software applications on a network host that are responsible for originating and/or receiving network traffic flows, referred to as network flows. Some network applications may be well-behaved and conform with a network's rules and policies. Other network applications may be poorly-behaved, installing without a user's or network administrator's permission, hiding themselves and their operation, and violating a network's rules and policies. Examples of poorly-behaved network applications may include computer viruses, worms, spyware, and malware applications. Additionally, some more legitimate applications, such as instant messaging applications, file-sharing or other types of peer-to-peer network applications, voice-over IP (VOIP) communication applications, and multimedia applications may be responsible for network flows that can circumvent network policies and jeopardize network security and reliability.

Accordingly, what is desired is to solve problems relating to visualizing information obtained in response to monitoring network applications, some of which may be discussed herein. Additionally, what is desired is to reduce drawbacks related to processing information obtained in response to monitoring network applications for creating graphical summaries of network activity, some of which may be discussed herein.

### BRIEF SUMMARY OF THE INVENTION

The following portion of this disclosure presents a simplified summary of one or more innovations, embodiments, and/or examples found within this disclosure for at least the purpose of providing a basic understanding of the subject matter. This summary does not attempt to provide an extensive overview of any particular embodiment or example. Additionally, this summary is not intended to identify key/critical elements of an embodiment or example or to delineate the scope of the subject matter of this disclosure. Accordingly, one purpose of this summary may be present some innovations, embodiments, and/or examples found within this disclosure in a simplified form as a prelude to a more detailed description presented later.

In various embodiments, techniques are provided for creating visualizations of network traffic. One or more computer systems configured to generate visualizations of network traffic may receive a plurality of categories for applications associated with network traffic. Network traffic information may be obtained in response to monitoring network traffic associated with a communications network. The network traffic information may include a variety of detailed or summary analysis of network traffic. A hierarchy of applications may be determined for each category in the plurality of categories based on applications represented in the network traffic information. One or more of a variety of visual representations of the network traffic information may then be generated based on each category in the plurality of categories.

In some embodiments, a plurality of categories for applications may be provided for the network traffic. At least one application category associated with management of applications may be provided. At least one application category associated with functionality of one or more applications may also be provided. One or more of a variety of visual representations of the network traffic information may then be generated based on the different categories for application management, filtering, functionality, or the like. One or more relationships between application categories may be determined according to one or more metrics to provide a hierarchy of application categories. One or more of a variety of visual representations of the network traffic information may then be generated with information that represents the one or more relationships between application categories in the hierarchy according to visual properties, such as the size of a polygon, color of a visual element, or the like. In one embodiment, a visual representation of the network traffic information may be generated based on information configured to represent size of a rectangular category node relative to each rectangular category node in a series of rectangular category nodes bound within a predefined rectangular area.

In further embodiments, one or more relationships between applications represented in the network traffic may be determined according to one or more metrics to provide a hierarchy of the applications themselves. Metrics may include byte counts, hit counts, time spent, user information, application rankings, or the like. One or more of a variety of visual representations of the network traffic information may then be generated with information configured to represent the one or more relationships between applications in the hierarchy according to one or more visual properties, such as size, color, or the like. In one embodiment, a visual representation of the network traffic information may be generated based on information configured to represent size of a rectangular application node relative to each rectangular application node in a series of rectangular application nodes bound within a predefined rectangular area associated with a particular category in a hierarchy of application categories. In another embodiment, a visual representation of the network traffic information may be generated based on information configured to represent color of a rectangular application node relative to each rectangular application node in a series of rectangular application nodes bound within a predefined rectangular area associated with a particular category in a hierarchy of application categories.

In still further embodiment, users or groups may be determined based on applications represented in the network traffic information. Hierarchies of users or groups for each application or application category may be determined according to one or more metrics. One or more of a variety of visual representations of the network traffic information may be generated with information that is configured to represent size of a rectangular user or group node relative to each rectangular user or group node in a series of rectangular user or group nodes bound within a predefined rectangular area. One or more of a variety of visual representations of the network traffic information may be generated with information that is configured with information configured to represent color of a rectangular user or group node relative to each rectangular user or group node in a series of rectangular user or group nodes bound within a predefined rectangular area.

In some embodiments, user interfaces may take advantage of pop-up or drill-down techniques for exploiting the a variety of visual representations of the network traffic information that may be generated. One or more user interfaces may enable a user to interact with a determined portion of the network traffic information corresponding to a selected application. In another aspect, one or more user interfaces may enable a user to specify search criteria provide visual representations of the network traffic information based on each application, application category, user or group that satisfy the search criteria. One or more user interfaces may enable a user to apply a variety of individual or combinational filters that provide visual representations of the network traffic information that satisfy filter criteria.

Additional systems configured with hardware and/or software, non-transitory computer-readable media manufactured with or prepared to store computer programs having code, instructions, and/or data, and various means for implementing described functionality that may be attributed to various structures, algorithms, or method discussed herein are also contemplated by this disclosure.

A further understanding of the nature of and equivalents to the subject matter of this disclosure (as well as any inherent or express advantages and improvements provided) should be realized in addition to the above section by reference to the remaining portions of this disclosure, any accompanying drawings, and the claims.

### BRIEF DESCRIPTION OF THE DRAWINGS

In order to reasonably describe and illustrate those innovations, embodiments, and/or examples found within this disclosure, reference may be made to one or more accompanying drawings. The additional details or examples used to describe the one or more accompanying drawings should not be considered as limitations to the scope of any of the claimed inventions, any of the presently described embodiments and/or examples, or the presently understood best mode of any innovations presented within this disclosure.

FIG. 1 is a block diagram of a system that may incorporate techniques for creating graphical summaries of network activity in various embodiments according to the present invention.

FIG. 2 is a block diagram of an embodiment of a network traffic manager that may be included in the system of FIG. 1 in one embodiment according to the present invention.

FIG. 3 is a flowchart of a method for creating graphical summaries of network activity in one embodiment according to the present invention.

FIG. 4 is a flowchart of a method for creating visual representations of categories of applications represented in network traffic in one embodiment according to the present invention.

FIG. 5 is an illustration representing a user interface providing one or more graphical summaries of network activity related to applications in one embodiment according to the present invention.

FIG. 6 is a flowchart of a method for creating visual representations that may be found in the user interface of FIG. 5 of applications represented in network traffic provided in an application hierarchy for an application category in one embodiment according to the present invention.

FIG. 7 is an illustration representing a user interface providing one or more graphical summaries of network activity related to users or groups in one embodiment according to the present invention.

FIG. 8 is a flowchart of a method for creating visual representations that may be found in the user interface of FIG. 7 of users or groups interacting with applications represented in network traffic in one embodiment according to the present invention.

FIG. 9 is an illustration representing a user interface providing one or more options for controlling how graphical summaries of network activity are presented in one embodiment according to the present invention.

FIG. 10 is an illustration representing a user interface providing one or more options for selecting information related to users or groups to control how graphical summaries of network activity are presented in one embodiment according to the present invention.

FIG. 11 is an illustration representing a user interface providing one or more options for searching or filtering information provided in one or more graphical summaries of network activity in one embodiment according to the present invention.

FIG. 12 is an illustration representing a user interface allowing a user to drill down on one or more graphical summaries of network activity in one embodiment according to the present invention.

FIG. 13 is an illustration representing a user interface providing a dashboard of views for graphical summaries of network activity in one embodiment according to the present invention.

FIG. 14 is a block diagram of a computer system or information processing device that may incorporate an embodiment, be incorporated into an embodiment, or be used to practice any of the innovations, embodiments, and/or examples found within this disclosure.

### DETAILED DESCRIPTION OF THE INVENTION

In various embodiments, techniques are provided for creating visualizations of network traffic. Such disclosed techniques may be incorporated by or implemented by one or more computing devices, computer systems, embedded systems, application-specific circuitry, or the like, that generate visualizations of network traffic. Network traffic information may be obtained in response to monitoring network traffic associated with a communications network. The network traffic information may include a variety of detailed or summary analysis of network traffic. In general, network traffic may summarized according to applications associated with network traffic. Hierarchies developed based on relationships between application categories, the applications themselves, and users or groups associated with the applications may be used to develop one or more of a variety of visual representations of the network traffic information.

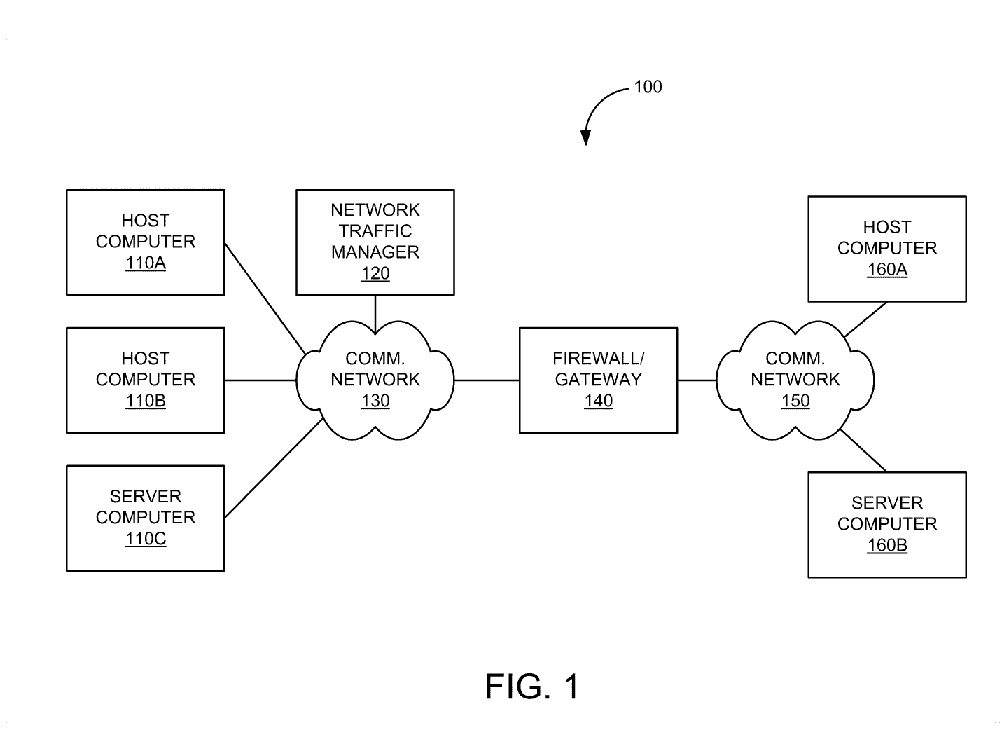

FIG. 1 is a block diagram of system 100 that may incorporate techniques for creating graphical summaries of network activity in various embodiments according to the present invention. In this example, system 100 can include one or more computers 110 (e.g., host computer 110A, host computer 110B, and server computer 110C), network traffic manager 120, communications network 130, firewall/gateway 140, communications network 150, and one or more computers 160 (e.g., server computer 160A and host computer 160B).

Computers 110 can include hardware and/or software elements configured for sending and/or receiving network traffic (e.g., network flows). Computers 110 may be embodied as any computing device. Some examples of computers 110 can include computer systems, personal computers (PC), laptops, workstations, server computers, blades, network appliances, mainframes, pocket PCs, personal digital assistants (PDAs), smartphones (BLACKBERRY OR IPHONE devices), telephones, cellular phones, pagers, etc, or other systems or devices having programmable processors or logic circuitry. Computers 110 may be embodied as network-enabled hosts and servers that include operating systems and execute software applications. In one example, host computer 110A may execute one or more software applications that send and receive instant message (IM) communications via communications networks 130 and/or 150. In another example, host computer 110B may execute one or more web browsers and one or more web-based applications that send and receive application-specific communications via communications networks 130 and/or 150. In yet another example, server computer 110C may execute one or more server software applications that provide application and/or data services via communications networks 130 and/or 150.

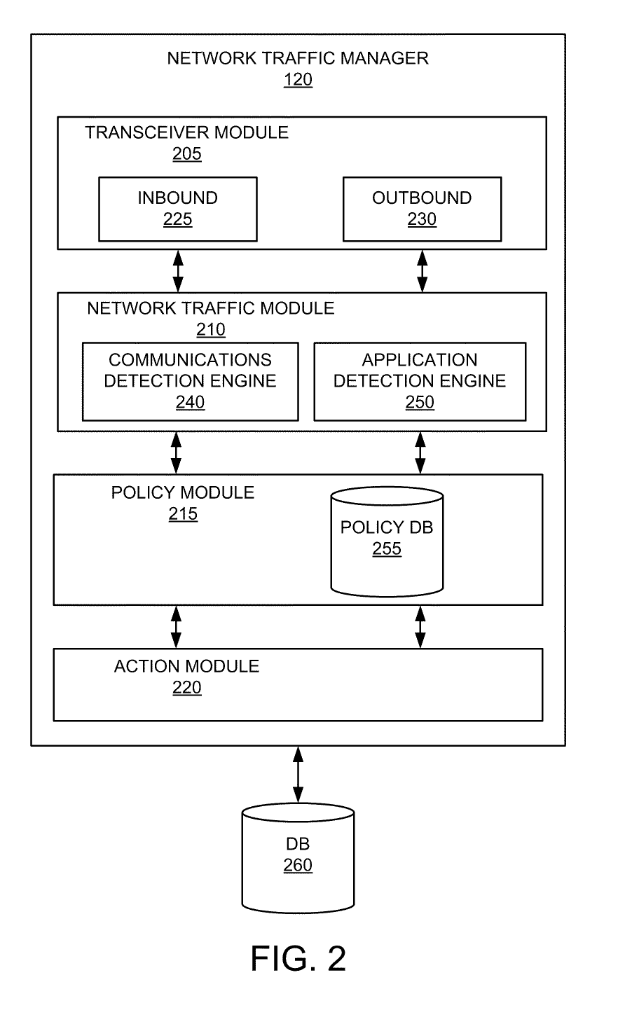

Network traffic manager 120 can include hardware and/or software elements configured for managing network traffic associated with communications network 130. Network traffic manager 120 also may be embodied as any computing device, such as those discussed above with respect to computers 110. Network traffic manager 120 also may be implemented as a standalone device, a cluster, a grid, one or more virtual machines, or the like. Management functionality of network traffic manager 120 may be embodied as a hardware and/or software component of a system offering network services, such as firewall protection, intrusion detection, antivirus/malware detection, host configuration services, domain name services, directory services, file/printer sharing services, or the like. One example of components that may be associated with some embodiments of network traffic manager 120 is discussed further with respect to FIG. 2.

In some embodiments, network traffic manager 120 may be implemented using a proxy server model, a server model, an event model, or any combination thereof. In a proxy server model, network traffic manager 120 may be situated to be in communication with communications network 130 and configured to act as a proxy or intermediary for communications between computers 110 coupled to communications networks 130. In a proxy server model, network traffic manager 120 may be situated to be in communication with communications network 130 and configured to act as a proxy or intermediary for communications between computers 110 and computers 160 coupled to communications network 150. Network traffic manager 120 may support one or more communications protocols, such as any kind of open source, commercially available, or reverse engineered proprietary communications protocols, and proxy mechanisms thereof (e.g., SOCKS, HTTP, HTTPS).

In a proxy server model, network traffic manager 120 may proxy network traffic or network flows originating from computers 110 or destined to computers 110. In one example, host computer 110A may connect to computers 110 coupled to communications networks 130 and computers 160 coupled to communications network 150 for communication using network traffic manager 120 by specifying host and port settings of network traffic manager 120 in proxy settings/preferences of host computer 110A. Network traffic manager 120 may then negotiate connections and communications on behalf of and to host computer 110A. Network traffic manager 120 may also maintain logs, records, or histories of network traffic received from and forwarded to host computer 110A.

In a server model, network traffic manager 120 network traffic manager 120 may be situated to be in communication with communications network 130 and configured to communicate with hosts coupled to communications networks 130 and 150 in a client-server fashion. Network traffic manager 120 may support one or more communications protocols, such as any kind of any kind of open source, commercially available, or reverse engineered proprietary protocols, (e.g., HTTP, HTTPS, FTP, SMTP, POP3, IMAP, IM protocols, SIP, etc.). For example, network traffic manager 120 may communicated with host computer 110B using a proprietary messaging protocol that is specially defined for use between host computer 110B and network traffic manager 120.

In an event model, network traffic manager 120 may be situated to be in communication with another system or device (e.g., directly or through communications network 130) and configured to interact with the another system or device based on one or more events generated by the another system or device. In various embodiments, network traffic manager 120 may be coupled directly or indirectly to a router or network appliance deployed in communications network 130. In one example, a router or network appliance may be responsible for sending events to network traffic manager 120 based on an analysis of a network flow. An event may include information indicating an occurrence in network traffic observed by a router or network appliance (e.g., an HTTP GET request, an IM client signed on/off; an IM client sent a text message to another IM client; the presence status of an IM client has changed; or the like). Once receiving an event, network traffic manager 120 may process information sent with the event or access event information from the router or appliance through an interface (typically an application programmer's interface, or API for short). Network traffic manager 120 thus receives events encapsulating various details concerning network traffic flows.

Communications network 130 can include hardware and/or software elements configured for communicating data. Some examples of communications network 130 can include a public network, a private network, an enterprise local area network, an extranet, a wide area network, a metropolitan area network, or the like. In some embodiments, communications network 130 may form an enterprise network that defined by firewall/gateway 140. Firewall 140 can include hardware and/or software elements configured for managing communications between communications networks 130 and 150, often to prevent information from leaving communications network 130 or limit exposure to attacks from communications network 150. In these embodiments, any devices behind firewall 140 may be considered part of the enterprise network. Other devices outside of firewall 140 may be considered to be outside of the enterprise network.

Communications network 150 can include hardware and/or software elements configured for communicating data. Some examples of communications network 150 can include a public network, a private network, an enterprise local area network, an extranet, a wide area network, a metropolitan area network, the Internet, or the like. In some embodiments, communications network 150 may provide network access to one or more servers, hosts, or information sources, such as computers 160. Host computer 160A can include hardware and/or software elements configured for communicating with one or more of computers 110 or computers 160. For example, host computer 160A may include a network host or other device providing a peer-to-peer (P2P) program, an instant messaging client or other chat program, a Skype or VOIP endpoint, or the like. Server computer 160A can include hardware and/or software elements configured for providing services to one or more of computers 110 or computers 160. For example, server computer 160B may include a server computer providing a web server, an application server, an FTP server, a VoIP server, or the like.

In one example of operation, network traffic monitor 120 may include or form part of an application detection architecture that attempts to detect and identify network-based applications from network traffic or flows. Network traffic monitor 120 may receive network traffic that may have been initiated by or originated from one or more network-based applications. A network-based application can include any software application, application component, plug-in, module, or set of code configured for sending data to a network host through a communications network or any software application, application component, plug-in, module, or set of code configured for receiving data send from a network host through a communications network. Once an application is identified, network traffic monitor 120 may determine and/or enforce rules, policies, procedures, audits, or the like, based on the detected applications or devices/users/groups associated with the detected application.

FIG. 2 is a block diagram of an embodiment of network traffic manager 120 that may be included in system 100 of FIG. 1 in one embodiment according to the present invention. Network manager 120 may be embodied as a single computing device or as multiple computing devices implementing different aspects of the disclosed functionality. In this example, network traffic manager 120 includes transceiver module 205, network traffic module 210, policy module 215, and action module 220.

Transceiver module 205 can include hardware and/or software elements configured for receiving data, such as from communications networks 130 and 150 or directly from another device, and for transmitting data, such as to a host coupled to one of communications networks 130 and 150 or directly to another device. In one embodiment, transceiver module 205 may include inbound transceiver module 225 and outbound transceiver module 230. Inbound transceiver module 225 can include hardware and/or software elements configured for receiving data. Inbound transceiver module 225 may handle network traffic received at one or more communications interfaces (not shown) associated with network traffic manager 120, such as from computers 110 or computers 160 of FIG. 1. Outbound transceiver module 230 can include hardware and/or software elements configured for transmitting data. Outbound transceiver module 230 may handle network traffic generated by or originating from network traffic manager 120 for transmission via one or more communications interfaces (not shown) associated with network traffic manager 120, which may include network traffic generated on behalf of computers 110 or to computers 160.

In various embodiments, transceiver module 205 can be communicatively coupled to network traffic module 210. Network traffic module 210 can include hardware and/or software elements configured for analyzing network traffic. In one example, network traffic module 210 may be responsible for identifying communications, such as emails, instant messages (IM), chat session data, or the like, in the network traffic. In another example, network traffic module 210 may be responsible for identifying an application that produced the network traffic or network flow. In another example, network traffic module 210 may be responsible for identifying users, groups, and/or machines responsible for the network traffic. In other embodiments, network traffic manager may directly or indirectly determine or enforce rules, policies, privileges, or the like, for detected applications.

In some embodiments, network traffic module 210 can receive network flows to be analyzed or data about the network flows to be analyzed from different sources. For example, network traffic monitor 120 may receive network traffic or network flows monitored directly in system 100. In another example, network traffic monitor 120 may receive data about network flows from another device in system 100, such as one or more of computers 110. Network traffic module 210 can collect the information on network flows being sent from or received by network-based applications within system 100. Some examples of the information collected, either directly from network traffic or from other sources can include the source and destination addresses of network packets, the size of network data in network packets, the contents of network packets, the rate of related network packets in a network flow, other attributes of one or more network packets in a network flow, host information, user information, operating system information, or the like.

In various embodiments, network traffic module 210 can use the information on network flows being sent from or received by network-based applications to reliably identify communications and any associated network-based applications. Network traffic module 210 may employ a variety of techniques for detecting and identifying a given communication and its associated network-based application. For example, network traffic module 210 may include communications detection engine 240. Communications detection engine 240 may include hardware and/or software elements configured for network communications processing and detection.

In various embodiments, network traffic module 210 can use the information on network flows being sent from or received by network-based applications to reliably identify the network flows and any associated network-based applications. Network traffic module 210 may employ a variety of techniques for detecting and identifying a given network-based application. For example, network traffic module 210 may include application detection engine 250. Application detection engine 250 may include hardware and/or software elements configured as one or more inspection engines. These inspection engines may be loaded at startup or runtime for network traffic processing and application detection. An inspection engine may be configured by configuration data, such as detection rules that may be dynamically loaded and updated.

In various embodiments, network traffic module 210 can be communicatively coupled to and interface with policy module 215. Policy module 215 can include hardware and/or software elements configured for providing and enforcing policies for network traffic or network flows. A policy can include a set of rules, conditions, and actions. A policy may further be associated with one or more users, groups of users, applications, devices, machines, or the like. Policies can be used to block, throttle, accelerate, enhance, or transform network traffic that is part of an identified network flow. In an embodiment, policies for network flows may be enforced by network traffic controlling devices such as switches, routers, firewalls, proxies, IPS, and EPS systems. Network traffic module 210 and policy module 215 can communicate with network traffic controlling devices via any interface or protocol, such as SNMP.

Policy module 215 may be configure to access a number of policies. In one embodiment, policy module 215 may include policy database 255 that stores a set of policies. As shown, policy database 255 is located in policy module 215; however, it will be understood that policy database 255 may be located anywhere in network traffic manager 120 or be separate from network traffic manager 120.

The policies in policy database 255 may include information about actions that can be taken by network traffic monitor 120. The policies may be applied to a packet, group of packets, a network flow, a user, a device, or the like. Policy module 215 may determine from user information, group information, machine information, characteristics related to network flows, or the like whether any policies in policy database 255 applies. Policy module 215 may communicate with network traffic module 210 to enforce policies for detected applications. Once a policy is determined by policy module 215, action module 220 may be configured to perform the action corresponding to the determined policy.

In various embodiments, database 260 may be used to store information usable for network traffic monitor 120. Database 260 may be included in network traffic monitor 120 or be separate from network traffic monitor 120. In one embodiment, database 260 can includes one or more information items including but not limited to: credential information, user information, user to IP address mappings, client identifications for computers 110, policies that may be implemented by policy module 215, or the like. This information is used by modules in network traffic manager 120 for any purpose.

Accordingly, in various embodiments, network traffic manager 120 can detect and identify network-based applications that initiate network flows. A layered approach employed by network traffic manager 120 in some embodiments to application detection can provide scalability and speed, while further providing quick assessments that move from simplest to complex for rapid detection and policy enforcement.

In further embodiments, network traffic manager 120 (or one or more computer systems in communication with network traffic manager 120) may include hardware and/or software elements configured for creating visualizations of network traffic. A visual representation of the network traffic information may be generated to represent a “heat map.” A heat map can include a graphical representation of data where values taken by a variable in a two-dimensional map for example are represented using one or more visual properties, typically colors. A similar presentation form may include a tree map where hierarchical (tree-structured) data can be represented as a set of nested rectangles. Each branch of a represented tree can be given a rectangle, which is then tiled with smaller rectangles representing sub-branches. A leaf node's rectangle can have an area proportional to a specified dimension on the data. A leaf nodes may also be colored to show a separate dimension of the data.

Accordingly, in one aspect, when color and size dimensions are correlated in some way with a tree structure representing network traffic information, network administrators can more readily see patterns (e.g., usage patterns) that would be difficult to spot in other ways based on the amount of data that may be generated in monitoring organizational networks. In another aspect, graphical summaries of network activities having this form may make efficient use of space within user interfaces as they can legibly display more items on a screen simultaneously.

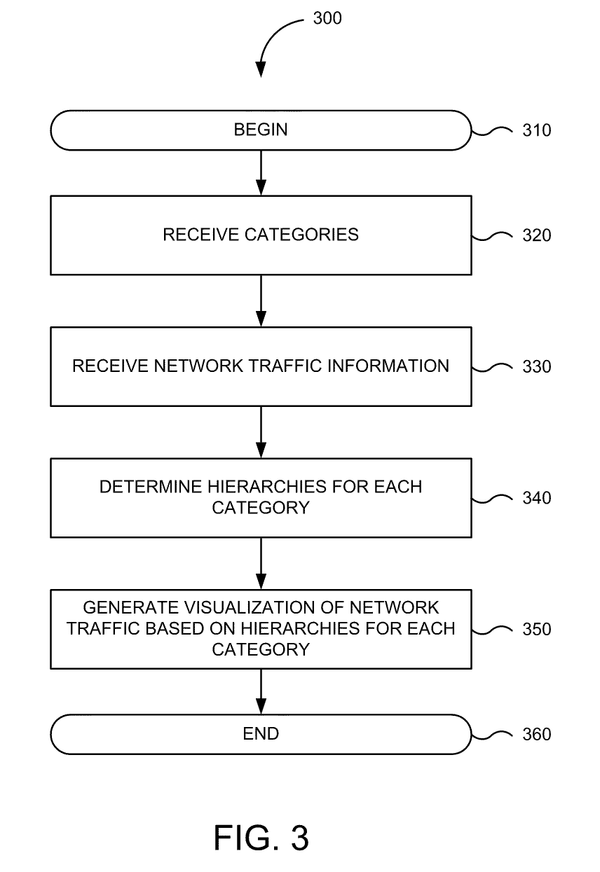

FIG. 3 is a flowchart of method 300 for creating graphical summaries of network activity in one embodiment according to the present invention. Implementations of or processing in method 300 depicted in FIG. 3 may be performed by software (e.g., instructions or code modules) when executed by a central processing unit (CPU or processor) of a logic machine, such as a computer system or information processing device, by hardware components of an electronic device or application-specific integrated circuits, or by combinations of software and hardware elements. Method 300 depicted in FIG. 3 begins in step 310.

In step 320, one or more categories are received. A category may correspond to how an application represented in network traffic is managed by network traffic manager 120. For example, one category may include applications whose access to computational or network resources is explicitly blocked or otherwise filtered by network traffic manager 120. In another example, a category may correspond to functionality of an application represented in network traffic, such as whether the application is an email application, a chat or instant messaging application, a voice or VOIP application, a file sharing application, or the like. In another example, a category may correspond to content accessed with or made available by an application represented in network traffic, such as whether the application accesses one or more social networks, streaming media services, search providers, or the like. Categories may be determined from the network traffic, manually by a user, or provided by a third party.

In step 330, network traffic information is received. In various embodiments, one or more computer systems functioning as described above with respect to network traffic manager 120 may monitor network traffic related to one or more communications networks. Network traffic information logged or otherwise generated by these computer systems may be aggregated in a repository for subsequent processing. Processing may occur directly on the captured network traffic or on summaries of the network traffic.

In step 340, one or more hierarchies are determined for each category. For example, hierarchical (tree-structured) data can be determined that represents applications represented in network traffic and assigned to each category. In another example, hierarchical (tree-structured) data can be determined that represents applications represented in network traffic and assigned within a selected category. In another example, hierarchical (tree-structured) data can be determined that represents users of applications represented in network traffic or groups of users of applications represented in network traffic.

In step 350, a visualization of the network traffic is generated based on the hierarchies for each category. For example, hierarchical (tree-structured) data can be visualized with a set of nested rectangles representing applications represented in network traffic and assigned to a selected category. In another example, hierarchical (tree-structured) data can be visualized with a set of nested rectangles representing users of applications represented in network traffic or groups of users of applications represented in network traffic. Accordingly, each branch of a tree structure to be graphically summarized can be given a rectangle representing a specific category, specific, application, application designation, user, group of users, or the like. A leaf node's rectangle can have an area proportional to a specified dimension or metric, such as a byte count, a number of bits, time spent, number of users or groups, proportion of users or groups, or one or more rankings or ratings assigned to an application, user, or group. A leaf nodes may also be colored to show a separate dimension of the data, such as a risk or threat level represented by use of a specified application whose data may be found in the network traffic. Method 300 of FIG. 3 ends in step 360.

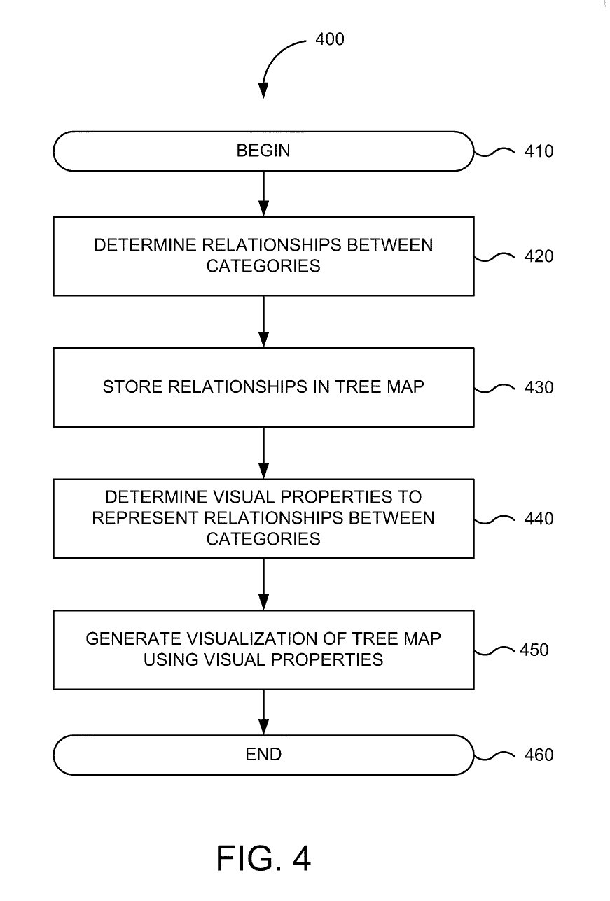

FIG. 4 is a flowchart of method 400 for creating visual representations of categories of applications represented in network traffic in one embodiment according to the present invention. Implementations of or processing in method 400 depicted in FIG. 4 may be performed by software (e.g., instructions or code modules) when executed by a central processing unit (CPU or processor) of a logic machine, such as a computer system or information processing device, by hardware components of an electronic device or application-specific integrated circuits, or by combinations of software and hardware elements. Method 400 depicted in FIG. 4 begins in step 410.

In step 420, relationships between categories are determined. Relationships between categories may be determined based on one or more metrics. Some examples of metrics may include information about an application, application usage information, application user information, application owner information, or the like. In one example, a relationship between two categories may be based on aggregate metric information related to applications assigned to an individual category.

In step 430, the relationships are stored in a tree map. One example of a tree map data structure is the “flex2treemap” by Josh Tynjala found at the URL “http://code.google.com/p/flex2treemap/” and may be used under an MIT license.

In step 440, one or more visual properties are determined to represent the relationships between categories. For example, size may be determined to visually represent relative quantification of metrics such as byte count, hit count, time spent, rankings or ratings, or the like associated with application represented in network traffic. In another example, color may be determined to visually represent relative quantification of metrics such as byte count, hit count, time spent, rankings or ratings, or the like associated with application represented in network traffic or users or groups of selected applications. In yet another example, color may be determined to visually represent relative risk levels, threat levels, resource burden, or the like of application represented in network traffic or users or groups of selected applications.

In step 450, a visualization of the tree map is generated using the determined visual properties. In one embodiment, one or more user interfaces may be generated provided graphical summaries of network activities generated in step 450. The user interfaces may summarize visually which categories having applications that generate the most traffic, are most used, represent the highest risk or threat level, or the like. Method 400 of FIG. 4 ends in step 460.

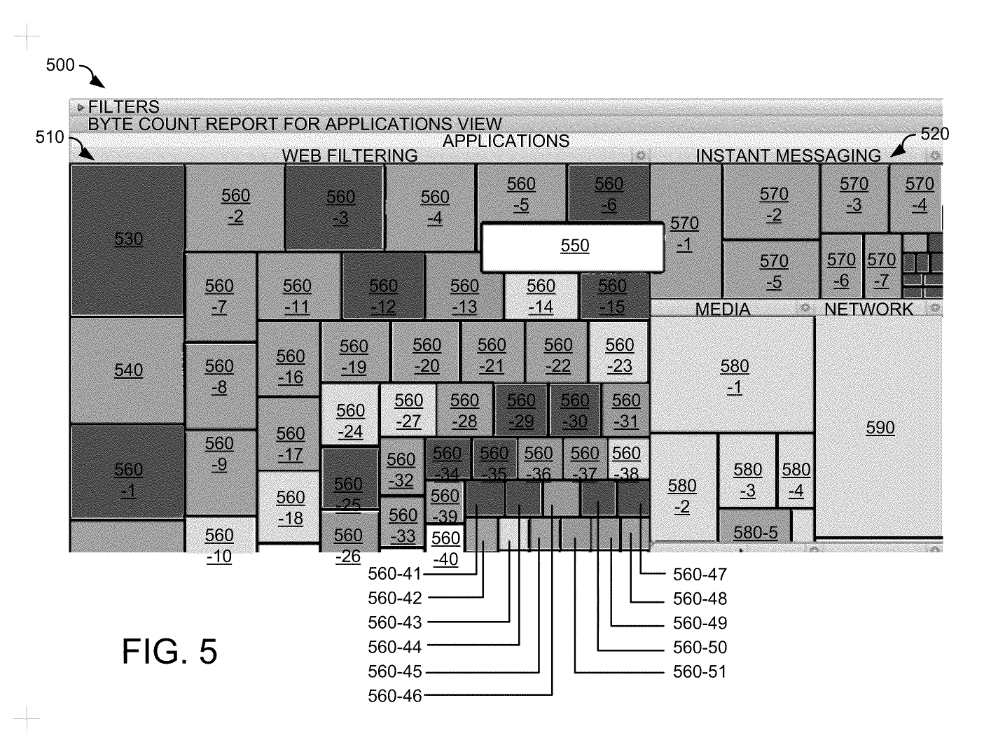

FIG. 5 is an illustration representing user interface 500 providing one or more graphical summaries of network activity related to applications in one embodiment according to the present invention. In this example, user interface 500 provides rectangles representing application categories nested within a predetermined area. Rectangle 510 represents an application category entitled “Web filtering.” Rectangle 520 represents an application category entitled “Instant Messaging.” At least one relationship between the application category entitled “Web filtering” and the application category entitled “Instant Messaging” is represented in that the size of rectangle 510 is greater than the size of rectangle 520.

User interface 500 further provides one or more rectangles representing applications whose data was detected in or otherwise determined to be present in network traffic used as the source for the graphical summaries. Rectangles 530 and 540 are nested within rectangle 510 entitled “Web filtering.” Rectangle 530 represents one or more applications entitled “Entertainment and Videos.” Rectangle 540 represents one or more applications entitled “Web-based Email.” At least one relationship between those applications entitled “Entertainment and Videos” and those applications entitled “Web-based Email” is represented in that the size of rectangle 530 is greater than the size of rectangle 540. In various embodiments, rectangles 530 and 540 may identify a particular application or grouping of applications by name and provide additionally textual summary information, such as whether an application has been blocked, filtered, allowed, or the like.

In further embodiments, one or more dialogs may be generated in response to placement of a pointer associated with a user's pointing device over a rectangle of user interface 500. For example, user interface 500 may include dialog 550 identifying a particular application or grouping of applications by name and provide additionally textual summary information, such as values associated with one or more metrics, or the like.

In this example, user interface 500 includes the following rectangles representing one or more applications:

| | |
|---|---|
| Rectangle 560-1 | Social Networking Space (Blocked) |
| Rectangle 560-2 | Miscellaneous (Allowed) |
| Rectangle 560-3 | Chat/IM (Blocked) |
| Rectangle 560-4 | Sports And Recreation (Allowed) |
| Rectangle 560-5 | Computers And Technology (Allowed) |
| Rectangle 560-6 | Sports And Recreation (Blocked) |
| Rectangle 560-7 | Search Engines (Allowed) |
| Rectangle 560-8 | Chat/IM (Allowed) |
| Rectangle 560-9 | Music (Allowed) |
| Rectangle 560-10 | Sports |
| Rectangle 560-11 | Adware (Allowed) |
| Rectangle 560-12 | Miscellaneous (Blocked) |
| Rectangle 560-13 | Miscellaneous (Coached) |
| Rectangle 560-14 | Intranet (Coached-Allowed) |
| Rectangle 560-15 | Computers And Technology (Blocked) |
| Rectangle 560-16 | Unknown (Allowed) |
| Rectangle 560-17 | Download Sites (Allowed) |
| Rectangle 560-18 | Gambling (Coached-Allowed) |
| Rectangle 560-19 | Portal Sites (Allowed) |
| Rectangle 560-20 | Business/Services (Allowed) |
| Rectangle 560-21 | Bhanwar_Custom (Custom) (Allowed) |
| Rectangle 560-22 | Intranet (Allowed) |
| Rectangle 560-23 | Computers And Technology (Coached-Allowed) |
| Rectangle 560-24 | Portal Sites (Coached-Allowed) |
| Rectangle 560-25 | Business/Services (Blocked) |
| Rectangle 560-26 | Search Engines (Coached) |
| Rectangle 560-27 | Social Networking (Coached-Allowed) |
| Rectangle 560-28 | Art (Allowed) |
| Rectangle 560-29 | Unknown (Blocked) |
| Rectangle 560-30 | Search Engines (Blocked) |
| Rectangle 560-31 | Adware (Coached) |
| Rectangle 560-32 | Finance (Allowed) |
| Rectangle 560-33 | Personal Webpages (Allowed) |
| Rectangle 560-34 | Finance (Blocked) |
| Rectangle 560-35 | Web-Based Email (Blocked) |
| Rectangle 560-36 | Portal Sites (Coach) |
| Rectangle 560-37 | Computers And Technology |
| Rectangle 560-38 | Travel (Coached-Allowed) |
| Rectangle 560-39 | Itc_Custom (Custom) (All) |
| Rectangle 560-40 | Itc_Custom (Custom) |
| Rectangle 560-41 | Spyware And Malicious |
| Rectangle 560-42 | Entertainment |
| Rectangle 560-43 | Government |
| Rectangle 560-44 | Portal Sites (Blocked) |
| Rectangle 560-45 | Travel (Allowed) |
| Rectangle 560-46 | Intranet (Coached) |
| Rectangle 560-47 | Bhanwar_Custom |
| Rectangle 560-48 | Job Search |
| Rectangle 560-49 | News (Coached ( |
| Rectangle 560-50 | Job Search (Blocked) |
| Rectangle 560-51 | Itc_Custom |
| Rectangle 570-1 | Google Talk (Allowed) |
| Rectangle 570-2 | IMhaha (Allowed) |
| Rectangle 570-3 | ILoveIM (Allowed) |
| Rectangle 570-4 | Yahoo Messenger (Allowed) |
| Rectangle 570-5 | eBuddy (Allowed) |
| Rectangle 570-6 | Goowy (Allowed) |
| Rectangle 570-7 | AIM/ICQ (Allowed) |
| Rectangle 580-1 | Social Networking (Threat) |
| Rectangle 580-2 | Social Networking (Moderate Threat) |
| Rectangle 580-3 | Multimedia (Moderate Threat) |
| Rectangle 580-4 | Facebook (Threat) |
| Rectangle 580-5 | Multimedia (Minor Annoyance) |
| Rectangle 590 | Remote Administration Tool (Threat) |

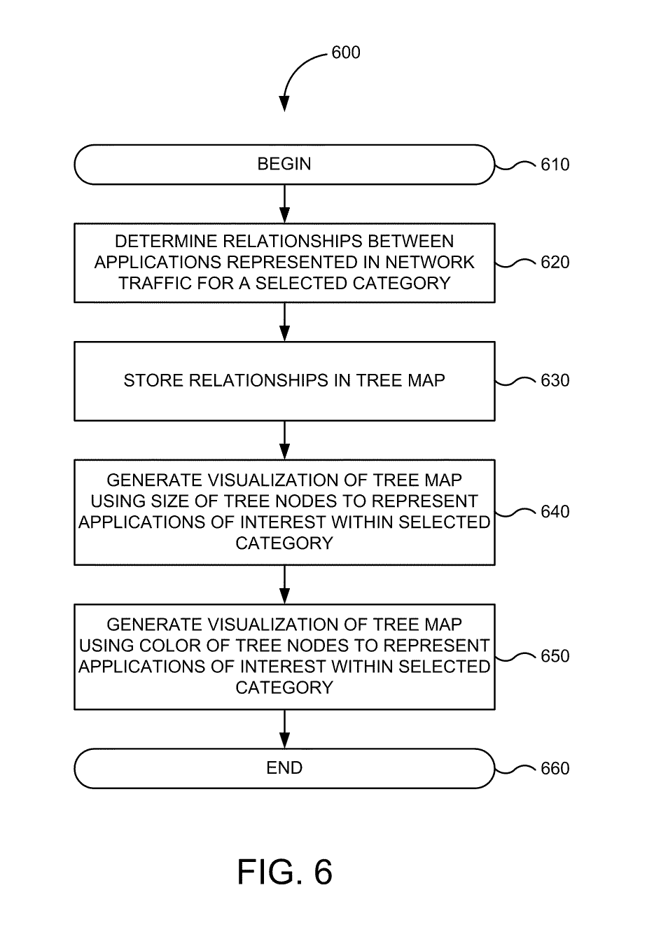

FIG. 6 is a flowchart of method 600 for creating visual representations that may be found in user 500 interface of FIG. 5 of applications represented in network traffic provided in an application hierarchy for an application category in one embodiment according to the present invention. Implementations of or processing in method 600 depicted in FIG. 6 may be performed by software (e.g., instructions or code modules) when executed by a central processing unit (CPU or processor) of a logic machine, such as a computer system or information processing device, by hardware components of an electronic device or application-specific integrated circuits, or by combinations of software and hardware elements. Method 600 depicted in FIG. 6 begins in step 610.

In step 620, relationships between applications represented in network traffic are determined for a selected category. Relationships between applications may be determined based on one or more metrics. Some examples of metrics may include information about an application, application usage information, application user information, application owner information, or the like. In one example, a relationship between two applications may be based on aggregate metric information related to other related or similarly functioning applications.

In step 630, the relationships are stored in a tree map. In step 640, a visualization of the tree map is generated using size of tree nodes to represent applications of interest within the selected category. In one embodiment, applications that generate the most traffic, are most used, represent the highest risk or threat level, or the like, may be represented by larger rectangles. In step 650, a visualization of the tree map is generated using color of tree nodes to represent applications of interest within the selected category. In one embodiment, applications that generate the most traffic, are most used, represent the highest risk or threat level, or the like, may be represented by colored rectangles, such as using red, yellow, green, or other color schemes. Method 600 of FIG. 6 ends in step 660.

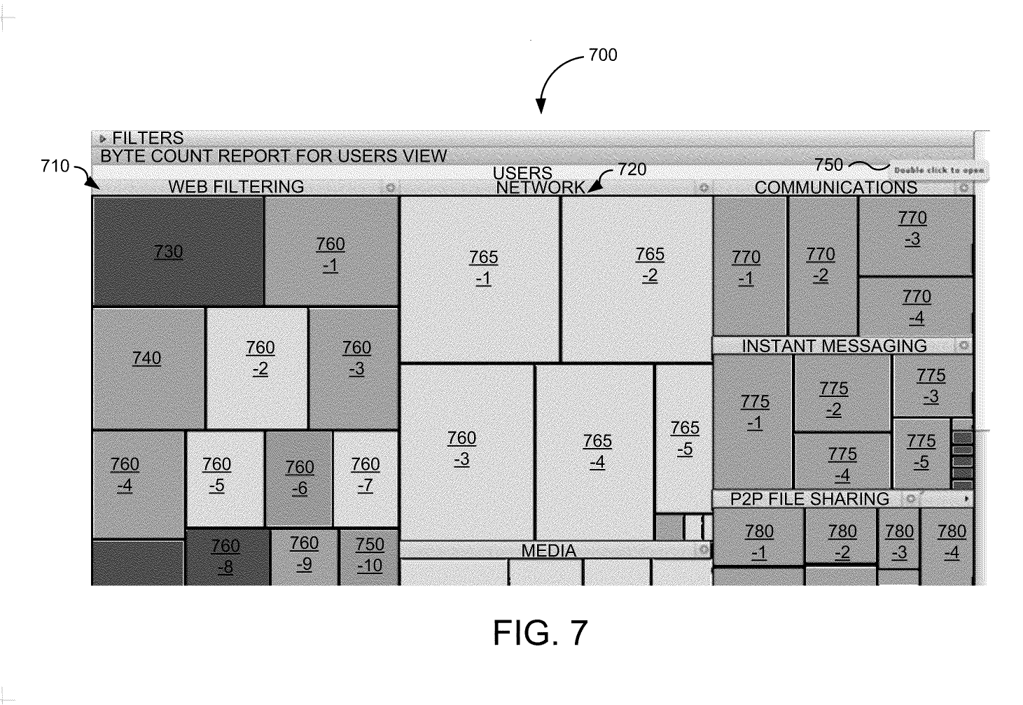

FIG. 7 is an illustration representing user interface 700 providing one or more graphical summaries of network activity related to users or groups in one embodiment according to the present invention. In this example, user interface 700 provides rectangles representing application categories nested within a predetermined area. Rectangle 710 represents an application category entitled “Web filtering.” Rectangle 720 represents an application category entitled “Network.” At least one relationship between the application category entitled “Web filtering” and the application category entitled “Network” is represented in that the size of rectangle 710 is greater than the size of rectangle 720.

User interface 700 further provides one or more rectangles representing users or groups of users or computers related to applications whose data was detected in or otherwise determined to be present in network traffic used as the source for the graphical summaries. Rectangles 730 and 740 are nested within rectangle 710 entitled “Web filtering.” Rectangle 730 entitled “Unmapped Group” represents users or groups of users or computers that are unknown or unable to be identified and who are unauthorized to generate network traffic. Rectangle 740 entitled “bhanwar_sharma1” represents one or more users or groups of users that are known or able to be identified and who are authorized to generate network traffic. At least one relationship between those users or groups entitled “Unmapped Group” and those users or groups entitled “bhanwar_sharma1” is represented in that the size of rectangle 730 is greater than the size of rectangle 740. In various embodiments, rectangles 730 and 740 may identify a particular user or group by name and provide additionally textual summary information, such as whether a user or group has been blocked, filtered, allowed, or the like.

In further embodiments, one or more dialogs may be generated in response to a selection (e.g., double-click) of a rectangle of user interface 500. For example, user interface 500 may include dialog 750 suggesting that more information is available for a particular user or group.

In this example, user interface 700 includes the following rectangles representing one or more applications:

| | |
|---|---|
| Rectangle 760-1 | Unmapped Group (Allowed) |
| Rectangle 760-2 | Bhanwar_Sharma1 (Allowed) |
| Rectangle 760-3 | Bhanwar (Allowed) |
| Rectangle 760-4 | Dynamic_Ldap (Allowed) |
| Rectangle 760-5 | Bhanwar (Coached-Allowed) |
| Rectangle 760-6 | Bhanwar (Coached) |
| Rectangle 760-7 | Bhanwar (Blocked) |
| Rectangle 760-8 | Aks@$%!\hat{ } (Allowed) |
| Rectangle 760-9 | Dynamic_Ldap (Coached) |
| Rectangle 765-1 | Bhanwar_Sharma1 (Threat) |
| Rectangle 765-2 | Bhanwar (Threat) |
| Rectangle 765-3 | Dynamic_Ldap (Threat) |
| Rectangle 765-4 | Unmapped Group (Threat) |
| Rectangle 765-5 | Aks@$%!\hat{ } (Threat) |
| Rectangle 770-1 | Bhanwar_Sharma1 (Minor Annoyance) |
| Rectangle 770-2 | Bhanwar (Minor Annoyance) |
| Rectangle 770-3 | Dynamic_Ldap (Minor Annoyance) |
| Rectangle 770-4 | Unmapped Group (Minor Annoyance) |
| Rectangle 775-1 | Unmapped Group (Allowed) |
| Rectangle 775-2 | Bhanwar_Sharma1 (Allowed) |
| Rectangle 775-3 | Bhanwar (Allowed) |
| Rectangle 775-4 | Aks@$%!\hat{ } (Allowed) |
| Rectangle 775-5 | Dynamic_Ldap (Allowed) |
| Rectangle 780-1 | Bhanwar_Sharma1 (Allowed) |
| Rectangle 780-2 | Unmapped Group (Allowed) |
| Rectangle 780-3 | Aks@$%!\hat{ } (Allowed) |
| Rectangle 780-4 | Bhanwar_Group1 (Allowed) |

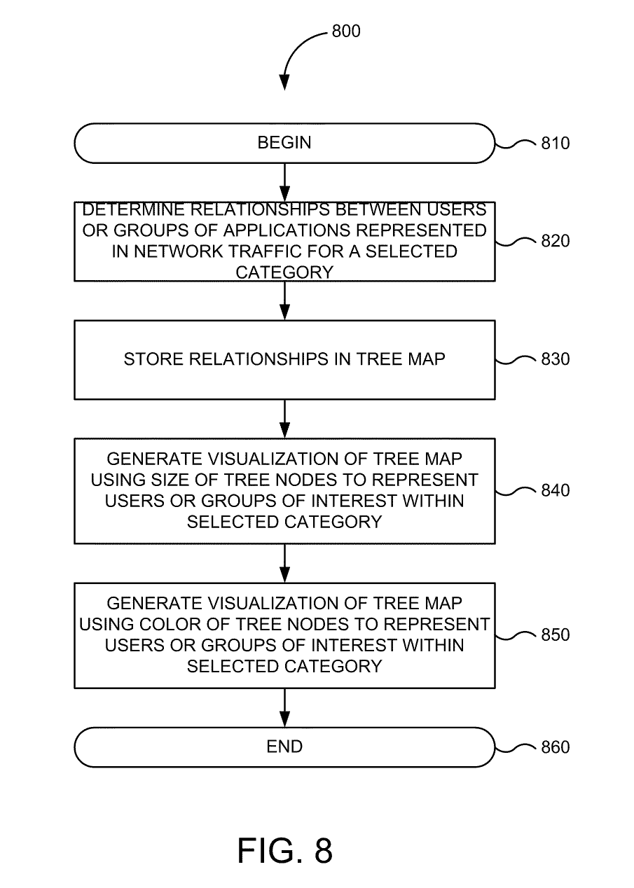

FIG. 8 is a flowchart of method 800 for creating visual representations that may be found in user interface 700 of FIG. 7 of users or groups interacting with applications represented in network traffic in one embodiment according to the present invention. Implementations of or processing in method 800 depicted in FIG. 8 may be performed by software (e.g., instructions or code modules) when executed by a central processing unit (CPU or processor) of a logic machine, such as a computer system or information processing device, by hardware components of an electronic device or application-specific integrated circuits, or by combinations of software and hardware elements. Method 800 depicted in FIG. 8 begins in step 810.

In step 820, relationships between users or groups of users or computers related to applications represented in network traffic are determined for a selected category. Relationships between users or groups of users or computers related to applications may be determined based on one or more metrics. Some examples of metrics may include information about an application, application usage information, application user information, application owner information, or the like. In one example, a relationship between two users or groups of users or computers related to applications may be based on aggregate metric information related to other related users or groups.

In step 830, the relationships are stored in a tree map. In step 840, a visualization of the tree map is generated using size of tree nodes to represent users or groups of users or computers related to applications of interest within the selected category. In one embodiment, users or groups of users or computers related to applications that generate the most traffic, have the most quantified usage, represent the highest risk or threat level, or the like, may be represented by larger rectangles. In step 850, a visualization of the tree map is generated using color of tree nodes to represent users or groups of users or computers related to applications of interest within the selected category. In one embodiment, users or groups of users or computers related to applications that generate the most traffic, have the highest data usage, represent the highest risk or threat level, or the like, may be represented by colored rectangles, such as using red, yellow, green, or other color schemes. Method 800 of FIG. 8 ends in step 860.

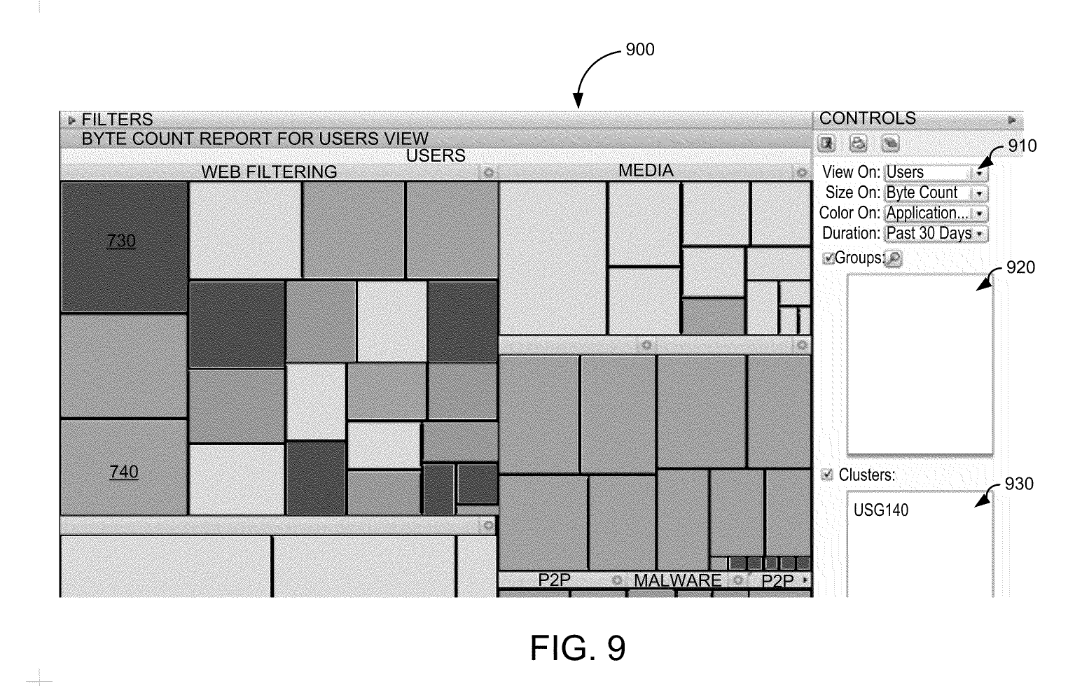

FIG. 9 is an illustration representing user interface 900 providing one or more options for controlling how graphical summaries of network activity are presented in one embodiment according to the present invention. In this example, user interface 900 includes various controls 910 for selecting which metrics may be used as a basis for graphical summaries. Controls 910 may be selectable to change a view based on one or more applications, users, groups or the like. Controls 910 may be selectable to change size of rectangles based on byte count, hit count, time spent, or the like. Controls 910 may be selectable to change color of rectangles based on applications ratings, threat rankings, user or group trust scores, or the like. Controls 910 may be selectable to change the duration or interval from which relationships may be determined.

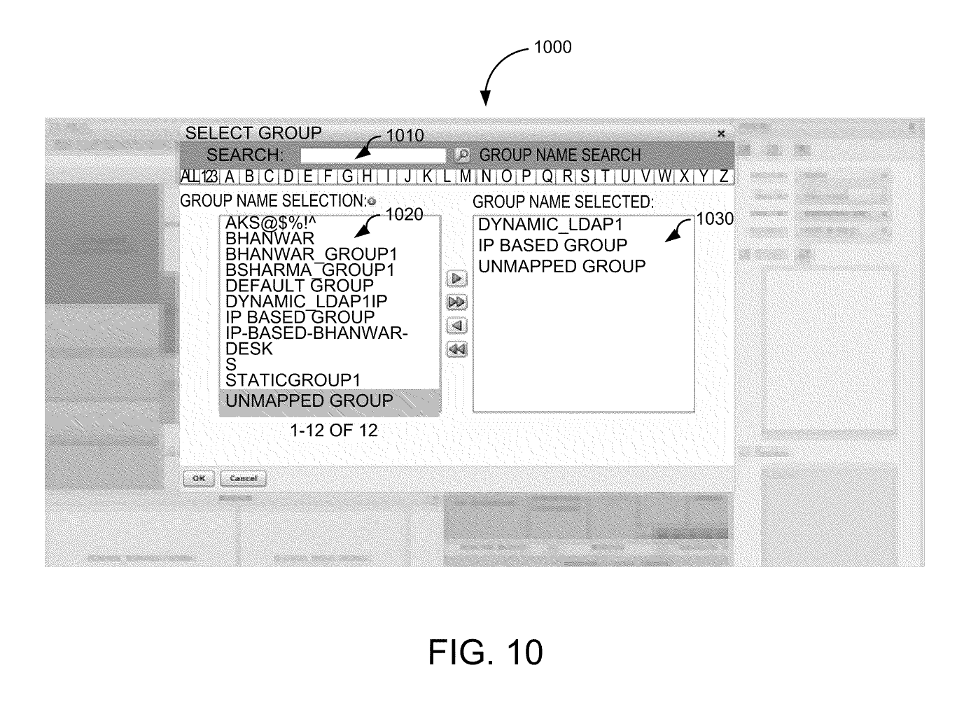

User interface 900 may also include control 920 for selecting which users or groups may be used as a basis for graphical summaries. FIG. 10 is an illustration representing user interface 1000 providing one or more options for selecting information related to users or groups to control how graphical summaries of network activity are presented in one embodiment according to the present invention. User interface 1000 includes search control 1010 for searching for a specific user or group. Control 1020 provides a list of users or groups that may be selected. Control 1030 provides a list of users or groups that currently have been selected.

Returning to FIG. 9, user interface 900 may also include control 930 for selecting a data source. In various embodiments, data may be aggregated from clusters of devices functioning as network traffic manager 120. Control 930 allows a user to select which device's data may be used.

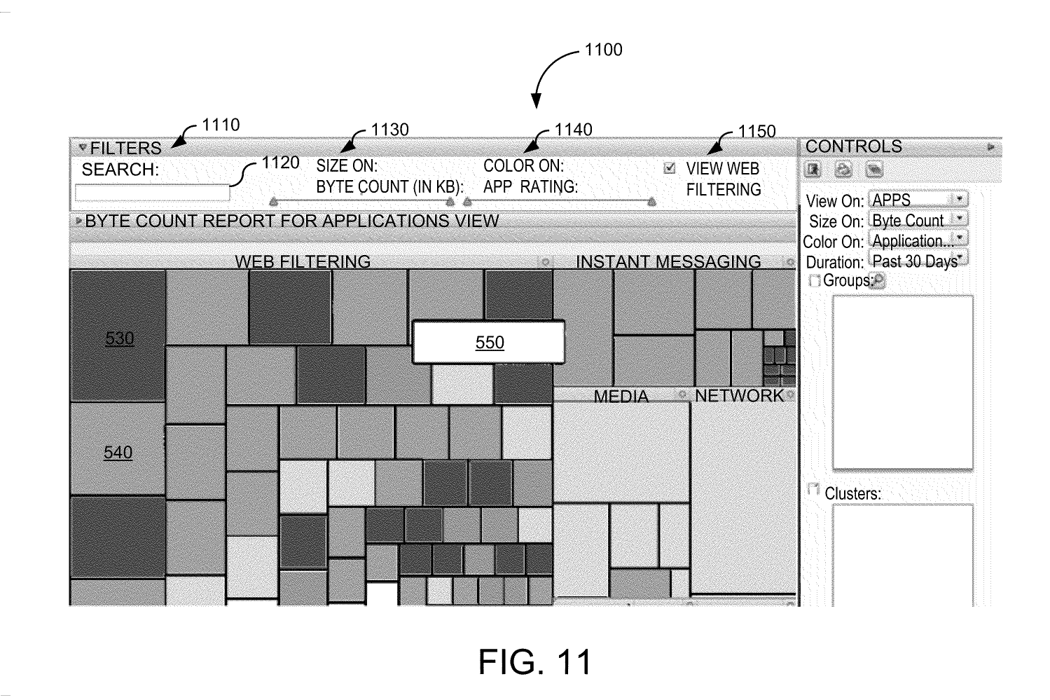

FIG. 11 is an illustration representing user interface 1100 providing one or more options for searching or filtering information provided in one or more graphical summaries of network activity in one embodiment according to the present invention. In this example, control 1110 enables access to one or more filters. User interface 1100 may include search control 1120 that enables a user to specify search criteria. The graphical summaries within user interface 1100 may be modified, updated, or filtered based on the search criteria.

User interface 1100 may also include control 1130 for selecting a size based on byte count. User interface 1100 may include control 1140 for selecting a color based on application ratings. User interface 1100 may include control 1150 for enabling or disabling disply of data generated in response to various filtering techniques.

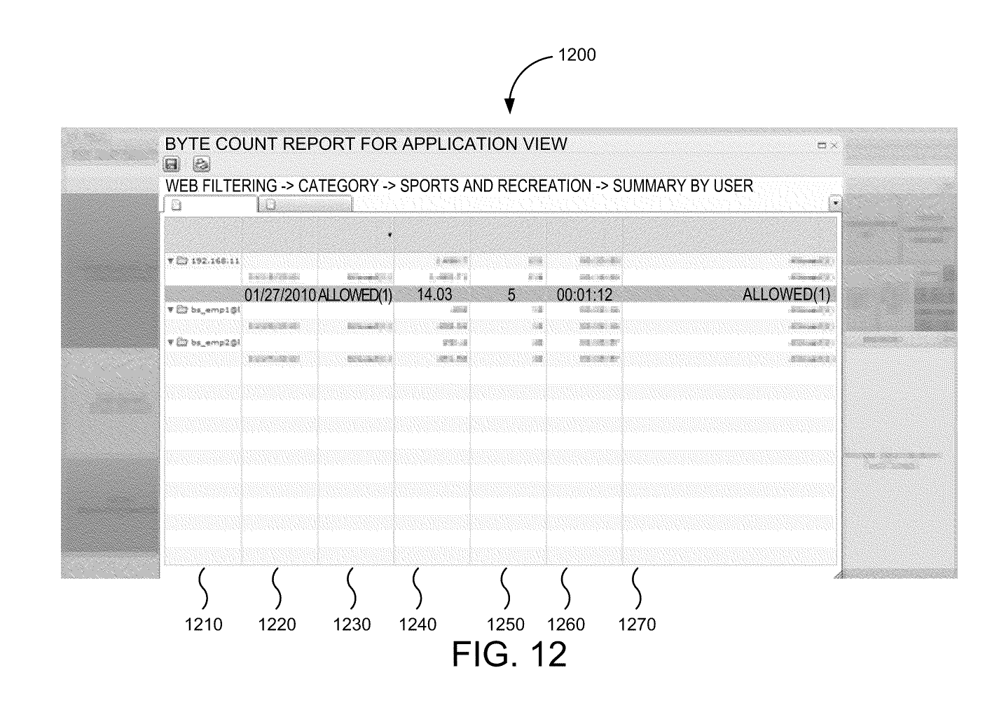

FIG. 12 is an illustration representing user interface 1200 allowing a user to drill down on one or more graphical summaries of network activity in one embodiment according to the present invention. User interface 1200 may include column 1210 entitled “EmployeeID” representing information about a user or group. User interface 1200 may include column 1220 entitled “Day” representing information about when data was monitored or captured. User interface 1200 may include column 1230 entitled “ApplicationRating” representing whether an application is authorized for use on a communications network by an organization and/or a quantification of any security threats, maliciousness, or potential for abuse attributed to the application. User interface 1200 may include column 1240 entitled “Sum of Byte Count” representing information about the total number of bytes monitored or captured that may be attributed to an application, group, or user. User interface 1200 may include column 1250 entitled “Hit Count” representing information about the total number of hits monitored or captured. This may represent how many times an application, user, or group, attempted to access a give resource, such as a URL. User interface 1200 may include column 1260 entitled “Sum of Time Spent” representing information about how long a monitored or captured application, user, or group, access a resource or was active on a communications network. User interface 1200 may include column 1270 entitled “Max of Application Rating.”

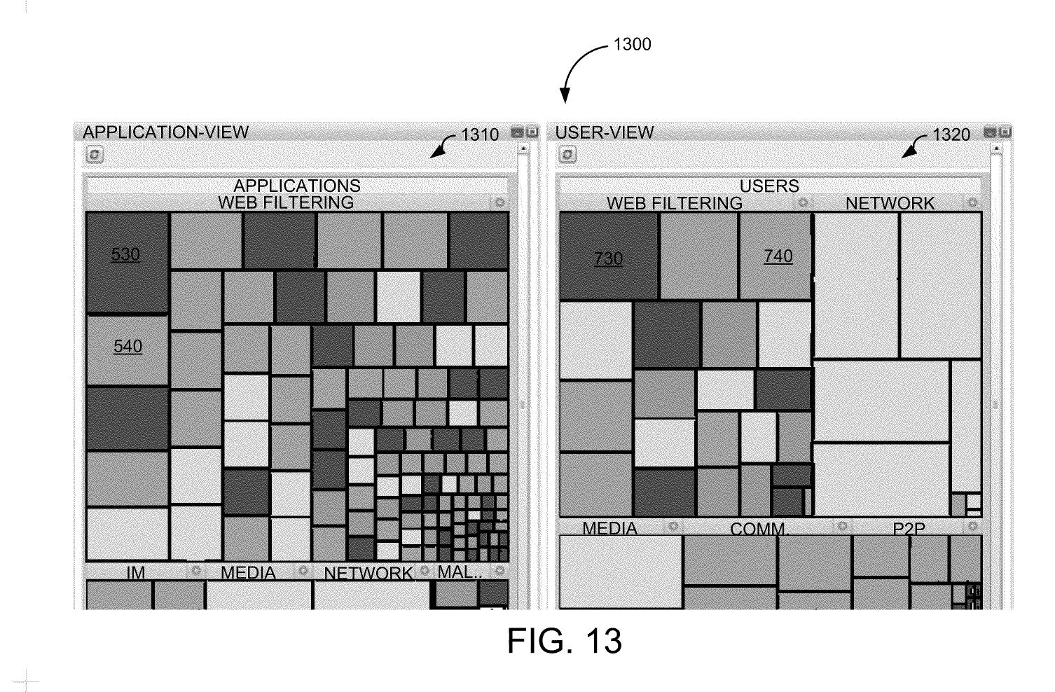

FIG. 13 is an illustration representing user interface 1300 providing a dashboard of views for graphical summaries of network activity in one embodiment according to the present invention. In this example, view 1310 may be presented to a user to provide graphical summaries of network activity for applications. View 1320 may be presented to a user to provide graphical summaries of network activity for users or groups related to applications. In various embodiments, views 1310 and 1320 may be saved and customized according to user preferences.

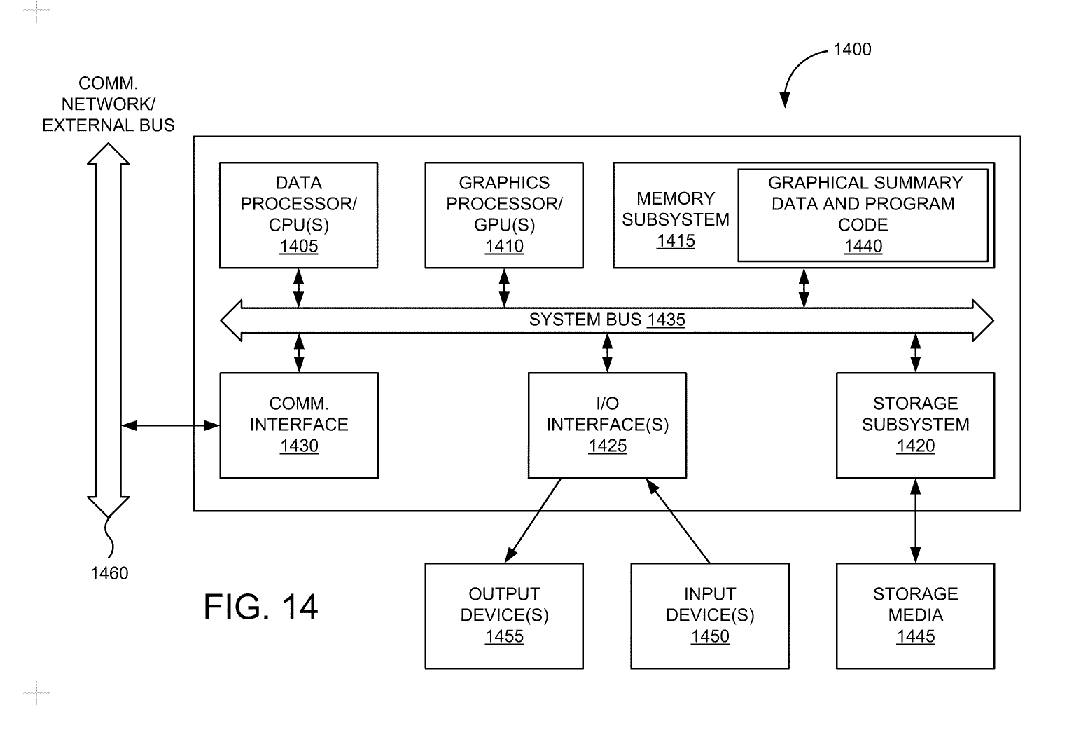

FIG. 14 is a block diagram of computer system 1400 that may incorporate an embodiment, be incorporated into an embodiment, or be used to practice any of the innovations, embodiments, and/or examples found within this disclosure. FIG. 14 is merely illustrative of a computing device, general-purpose computer system programmed according to one or more disclosed techniques, or specific information processing device for an embodiment incorporating an invention whose teachings may be presented herein and does not limit the scope of the invention as recited in the claims. One of ordinary skill in the art would recognize other variations, modifications, and alternatives.

Computer system 1400 can include hardware and/or software elements configured for performing logic operations and calculations, input/output operations, machine communications, or the like. Computer system 1400 may include familiar computer components, such as one or more one or more data processors or central processing units (CPUs) 1405, one or more graphics processors or graphical processing units (GPUs) 1410, memory subsystem 1415, storage subsystem 1420, one or more input/output (I/O) interfaces 1425, communications interface 1430, or the like. Computer system 1400 can include system bus 1435 interconnecting the above components and providing functionality, such connectivity and inter-device communication. Computer system 1400 may be embodied as a computing device, such as a personal computer (PC), a workstation, a mini-computer, a mainframe, a cluster or farm of computing devices, a laptop, a notebook, a netbook, a PDA, a smartphone, a consumer electronic device, a gaming console, or the like.

The one or more data processors or central processing units (CPUs) 1405 can include hardware and/or software elements configured for executing logic or program code or for providing application-specific functionality. Some examples of CPU(s) 1405 can include one or more microprocessors (e.g., single core and multi-core) or micro-controllers, such as PENTIUM, ITANIUM, or CORE 2 processors from Intel of Santa Clara, Calif. and ATHLON, ATHLON XP, and OPTERON processors from Advanced Micro Devices of Sunnyvale, Calif. CPU(s) 1405 may also include one or more field-gate programmable arrays (FPGAs), application-specific integrated circuits (ASICs), or other microcontrollers. The one or more data processors or central processing units (CPUs) 1405 may include any number of registers, logic units, arithmetic units, caches, memory interfaces, or the like. The one or more data processors or central processing units (CPUs) 1405 may further be integrated, irremovably or moveably, into one or more motherboards or daughter boards.

The one or more graphics processor or graphical processing units (GPUs) 1410 can include hardware and/or software elements configured for executing logic or program code associated with graphics or for providing graphics-specific functionality. GPUs 1410 may include any conventional graphics processing unit, such as those provided by conventional video cards. Some examples of GPUs are commercially available from NVIDIA, ATI, and other vendors. In various embodiments, GPUs 1410 may include one or more vector or parallel processing units. These GPUs may be user programmable, and include hardware elements for encoding/decoding specific types of data (e.g., video data) or for accelerating 2D or 3D drawing operations, texturing operations, shading operations, or the like. The one or more graphics processors or graphical processing units (GPUs) 1410 may include any number of registers, logic units, arithmetic units, caches, memory interfaces, or the like. The one or more data processors or central processing units (CPUs) 1405 may further be integrated, irremovably or moveably, into one or more motherboards or daughter boards that include dedicated video memories, frame buffers, or the like.

Memory subsystem 1415 can include hardware and/or software elements configured for storing information. Memory subsystem 1415 may store information using machine-readable articles, information storage devices, or computer-readable storage media. Some examples of these articles used by memory subsystem 1470 can include random access memories (RAM), read-only-memories (ROMS), volatile memories, non-volatile memories, and other semiconductor memories. In various embodiments, memory subsystem 1415 can include graphical summary data and program code 1440.

Storage subsystem 1420 can include hardware and/or software elements configured for storing information. Storage subsystem 1420 may store information using machine-readable articles, information storage devices, or computer-readable storage media. Storage subsystem 1420 may store information using storage media 1445. Some examples of storage media 1445 used by storage subsystem 1420 can include floppy disks, hard disks, optical storage media such as CD-ROMS, DVDs and bar codes, removable storage devices, networked storage devices, or the like. In some embodiments, all or part of graphical summary data and program code 1440 may be stored using storage subsystem 1420.

In various embodiments, computer system 1400 may include one or more hypervisors or operating systems, such as WINDOWS, WINDOWS NT, WINDOWS XP, VISTA, or the like from Microsoft or Redmond, Wash., SOLARIS from Sun Microsystems, LINUX, UNIX, and UNIX-based operating system. Computer system 1400 may also include one or more applications configured to executed, perform, or otherwise implement techniques disclosed herein. These applications may be embodied as graphical summary data and program code 1440. Additionally, computer programs, executable computer code, human-readable source code, shader code, rendering engines, or the like, and data, such as image files, models including geometrical descriptions of objects, ordered geometric descriptions of objects, procedural descriptions of models, scene descriptor files, or the like, may be stored in memory subsystem 1415 and/or storage subsystem 1420.

The one or more input/output (I/O) interfaces 1425 can include hardware and/or software elements configured for performing I/O operations. One or more input devices 1450 and/or one or more output devices 1455 may be communicatively coupled to the one or more I/O interfaces 1425.

The one or more input devices 1450 can include hardware and/or software elements configured for receiving information from one or more sources for computer system 1400. Some examples of the one or more input devices 1450 may include a computer mouse, a trackball, a track pad, a joystick, a wireless remote, a drawing tablet, a voice command system, an eye tracking system, external storage systems, a monitor appropriately configured as a touch screen, a communications interface appropriately configured as a transceiver, or the like. In various embodiments, the one or more input devices 1450 may allow a user of computer system 1400 to interact with one or more non-graphical or graphical user interfaces to enter a comment, select objects, icons, text, user interface widgets, or other user interface elements that appear on a monitor/display device via a command, a click of a button, or the like.

The one or more output devices 1455 can include hardware and/or software elements configured for outputting information to one or more destinations for computer system 1400. Some examples of the one or more output devices 1455 can include a printer, a fax, a feedback device for a mouse or joystick, external storage systems, a monitor or other display device, a communications interface appropriately configured as a transceiver, or the like. The one or more output devices 1455 may allow a user of computer system 1400 to view objects, icons, text, user interface widgets, or other user interface elements.

A display device or monitor may be used with computer system 1400 and can include hardware and/or software elements configured for displaying information. Some examples include familiar display devices, such as a television monitor, a cathode ray tube (CRT), a liquid crystal display (LCD), or the like.

Communications interface 1430 can include hardware and/or software elements configured for performing communications operations, including sending and receiving data. Some examples of communications interface 1430 may include a network communications interface, an external bus interface, an Ethernet card, a modem (telephone, satellite, cable, ISDN), (asynchronous) digital subscriber line (DSL) unit, FireWire interface, USB interface, or the like. For example, communications interface 1430 may be coupled to communications network/external bus 1480, such as a computer network, to a FireWire bus, a USB hub, or the like. In other embodiments, communications interface 1430 may be physically integrated as hardware on a motherboard or daughter board of computer system 1400, may be implemented as a software program, or the like, or may be implemented as a combination thereof.

In various embodiments, computer system 1400 may include software that enables communications over a network, such as a local area network or the Internet, using one or more communications protocols, such as the HTTP, TCP/IP, RTP/RTSP protocols, or the like. In some embodiments, other communications software and/or transfer protocols may also be used, for example IPX, UDP or the like, for communicating with hosts over the network or with a device directly connected to computer system 1400.

As suggested, FIG. 14 is merely representative of a general-purpose computer system appropriately configured or specific data processing device capable of implementing or incorporating various embodiments of an invention presented within this disclosure. Many other hardware and/or software configurations may be apparent to the skilled artisan which are suitable for use in implementing an invention presented within this disclosure or with various embodiments of an invention presented within this disclosure. For example, a computer system or data processing device may include desktop, portable, rack-mounted, or tablet configurations. Additionally, a computer system or information processing device may include a series of networked computers or clusters/grids of parallel processing devices. In still other embodiments, a computer system or information processing device may techniques described above as implemented upon a chip or an auxiliary processing board.

Various embodiments of any of one or more inventions whose teachings may be presented within this disclosure can be implemented in the form of logic in software, firmware, hardware, or a combination thereof. The logic may be stored in or on a machine-accessible memory, a machine-readable article, a tangible computer-readable medium, a computer-readable storage medium, or other computer/machine-readable media as a set of instructions adapted to direct a central processing unit (CPU or processor) of a logic machine to perform a set of steps that may be disclosed in various embodiments of an invention presented within this disclosure. The logic may form part of a software program or computer program product as code modules become operational with a processor of a computer system or an information-processing device when executed to perform a method or process in various embodiments of an invention presented within this disclosure. Based on this disclosure and the teachings provided herein, a person of ordinary skill in the art will appreciate other ways, variations, modifications, alternatives, and/or methods for implementing in software, firmware, hardware, or combinations thereof any of the disclosed operations or functionalities of various embodiments of one or more of the presented inventions.

The disclosed examples, implementations, and various embodiments of any one of those inventions whose teachings may be presented within this disclosure are merely illustrative to convey with reasonable clarity to those skilled in the art the teachings of this disclosure. As these implementations and embodiments may be described with reference to exemplary illustrations or specific figures, various modifications or adaptations of the methods and/or specific structures described can become apparent to those skilled in the art. All such modifications, adaptations, or variations that rely upon this disclosure and these teachings found herein, and through which the teachings have advanced the art, are to be considered within the scope of the one or more inventions whose teachings may be presented within this disclosure. Hence, the present descriptions and drawings should not be considered in a limiting sense, as it is understood that an invention presented within a disclosure is in no way limited to those embodiments specifically illustrated.

Accordingly, the above description and any accompanying drawings, illustrations, and figures are intended to be illustrative but not restrictive. The scope of any invention presented within this disclosure should, therefore, be determined not with simple reference to the above description and those embodiments shown in the figures, but instead should be determined with reference to the pending claims along with their full scope or equivalents.

What is claimed is:

1. A computer-implemented method for creating visualizations of network traffic, the method comprising:
receiving, at one or more computer systems, a plurality of categories for applications associated with network traffic;
receiving, at the one or more computer systems, network traffic information obtained in response to monitoring network traffic associated with a communications network;
determining, with one or more processors associated with the one or more computer systems, a hierarchy of applications for each category in the plurality of categories based on applications represented in the network traffic information; and
generating, with the one or more processors associated with the one or more computer systems, a visual representation of the network traffic information based on each category in the plurality of categories.

2. The method of claim 1 wherein receiving, at one or more computer systems, the plurality of categories for applications associated with network traffic comprises receiving at least one application category associated with management of applications and at least one application category associated with functionality of one or more applications.

3. The method of claim 1 wherein determining, with the one or more processors associated with the one or more computer systems, the hierarchy of applications for each category in the plurality of categories comprises determining one or more relationships between categories in the plurality of categories according to one or more metrics.

4. The method of claim 3 wherein generating, with the one or more processors associated with the one or more computer systems, the visual representation of the network traffic information comprises generating information configured to represent the one or more relationships between categories in the plurality of categories according to one or more visual properties.

5. The method of claim 3 wherein generating, with the one or more processors associated with the one or more computer systems, the visual representation of the network traffic information comprises generating information configured to represent size of a rectangular category node relative to each rectangular category node in a series of rectangular category nodes bound within a predefined rectangular area.

6. The method of claim 1 wherein determining, with the one or more processors associated with the one or more computer systems, the hierarchy of applications for each category in the plurality of categories comprises determining one or more relationships between applications in a selected hierarchy of applications according to one or more metrics.

7. The method of claim 6 wherein generating, with the one or more processors associated with the one or more computer systems, the visual representation of the network traffic information comprises generating information configured to represent the one or more relationships between applications in the selected hierarchy of applications according to one or more visual properties.

8. The method of claim 6 wherein generating, with the one or more processors associated with the one or more computer systems, the visual representation of the network traffic information comprises generating information configured to represent size of a rectangular application node relative to each rectangular application node in a series of rectangular application nodes bound within a predefined rectangular area associated with the category of the selected hierarchy of applications.

9. The method of claim 6 wherein generating, with the one or more processors associated with the one or more computer systems, the visual representation of the network traffic information comprises generating information configured to represent color of a rectangular application node relative to each rectangular application node in a series of rectangular application nodes bound within a predefined rectangular area associated with the category of the selected hierarchy of applications.

10. The method of claim 6 wherein the one or more metrics include byte count, hit counts, time spent, user information, or application rankings.

11. The method of claim 1 further comprising determining, with the one or more processors associated with the one or more computer systems, a hierarchy of users or groups for each category in the plurality of categories based on applications represented in the network traffic information.

12. The method of claim 11 wherein determining, with the one or more processors associated with the one or more computer systems, the hierarchy of users or groups for each category in the plurality of categories comprises determining one or more relationships between users or groups associated with applications represented in the network traffic information for a selected category in the plurality of categories according to one or more metrics.

13. The method of claim 11 wherein generating, with the one or more processors associated with the one or more computer systems, the visual representation of the network traffic information comprises generating information based on the determined hierarchy of users or groups for a selected category that is configured to represent size of a rectangular user or group node relative to each rectangular user or group node in a series of rectangular user or group nodes bound within a predefined rectangular area associated with the selected category.

14. The method of claim 11 wherein generating, with the one or more processors associated with the one or more computer systems, the visual representation of the network traffic information comprises generating information based on the determined hierarchy of users or groups for a selected category that is configured to represent color of a rectangular user or group node relative to each rectangular user or group node in a series of rectangular user or group nodes bound within a predefined rectangular area associated with the selected category.

15. The method of claim 1 further comprising:
receiving, at the one or more computer systems, information indicating selection of an application represented in the visual representation of the network traffic information;
determining, with the one or more processors associated with the one or more computer systems, a portion of the network traffic information corresponding to the selected application; and
generating, with the one or more processors associated with the one or more computer systems, information configured for displaying one or more user interfaces that enable a user to interact with the determined portion of the network traffic information corresponding to the selected application.

16. The method of claim 1 further comprising:
receiving, at the one or more computer systems, search criteria; and
generating, with the one or more processors associated with the one or more computer systems, another visual representation of the network traffic information based on each category in the plurality of categories that satisfy the search criteria.

17. The method of claim 1 further comprising:
receiving, at the one or more computer systems, filter criteria; and
generating, with the one or more processors associated with the one or more computer systems, another visual representation of the network traffic information based on each category in the plurality of categories that satisfy the filter criteria.

18. A computer-readable storage medium storing code configured to direct one or more processor associated with one or more computer system for creating visualizations of network traffic, the computer-readable storage medium comprising:
code for receiving a plurality of categories for applications associated with network traffic;
code for receiving network traffic information obtained in response to monitoring network traffic associated with a communications network;
code for determining a hierarchy of applications for each category in the plurality of categories based on applications represented in the network traffic information; and
code for generating a visual representation of the network traffic information based on each category in the plurality of categories.

19. The computer-readable storage medium of claim 18 wherein the code for receiving the plurality of categories for applications associated with network traffic comprises code for receiving at least one application category associated with management of applications and at least one application category associated with functionality of one or more applications.

20. The computer-readable storage medium of claim 18 wherein the code for determining the hierarchy of applications for each category in the plurality of categories comprises code for determining one or more relationships between categories in the plurality of categories according to one or more metrics.

21. The computer-readable storage medium of claim 20 wherein the code for generating the visual representation of the network traffic information comprises code for generating information configured to represent the one or more relationships between categories in the plurality of categories according to one or more visual properties.

22. The computer-readable storage medium of claim 20 wherein the code for generating the visual representation of the network traffic information comprises code for generating information configured to represent size of a rectangular category node relative to each rectangular category node in a series of rectangular category nodes bound within a predefined rectangular area.

23. The computer-readable storage medium of claim 18 wherein the code for determining the hierarchy of applications for each category in the plurality of categories comprises code for determining one or more relationships between applications in a selected hierarchy of applications according to one or more metrics.

24. The computer-readable storage medium of claim 23 wherein the code for generating the visual representation of the network traffic information comprises code for generating information configured to represent the one or more relationships between applications in the selected hierarchy of applications according to one or more visual properties.

25. The computer-readable storage medium of claim 23 wherein the code for generating the visual representation of the network traffic information comprises code for generating information configured to represent size of a rectangular application node relative to each rectangular application node in a series of rectangular application nodes bound within a predefined rectangular area associated with the category of the selected hierarchy of applications.

26. The computer-readable storage medium of claim 23 wherein the code for generating the visual representation of the network traffic information comprises code for generating information configured to represent color of a rectangular application node relative to each rectangular application node in a series of rectangular application nodes bound within a predefined rectangular area associated with the category of the selected hierarchy of applications.

27. The computer-readable storage medium of claim 23 wherein the one or more metrics include byte count, hit counts, time spent, user information, or application rankings.

28. The computer-readable storage medium of claim 18 further comprising code for determining a hierarchy of users or groups for each category in the plurality of categories based on applications represented in the network traffic information.

29. The computer-readable storage medium of claim 28 wherein the code for determining the hierarchy of users or groups for each category in the plurality of categories comprises code for determining one or more relationships between users or groups associated with applications represented in the network traffic information for a selected category in the plurality of categories according to one or more metrics.

30. The computer-readable storage medium of claim 28 wherein the code for generating the visual representation of the network traffic information comprises code for generating information based on the determined hierarchy of users or groups for a selected category that is configured to represent size of a rectangular user or group node relative to each rectangular user or group node in a series of rectangular user or group nodes bound within a predefined rectangular area associated with the selected category.

31. The computer-readable storage medium of claim 28 wherein the code for generating the visual representation of the network traffic information comprises code for generating information based on the determined hierarchy of users or groups for a selected category that is configured to represent color of a rectangular user or group node relative to each rectangular user or group node in a series of rectangular user or group nodes bound within a predefined rectangular area associated with the selected category.

32. The computer-readable storage medium of claim 18 further comprising:
code for receiving information indicating selection of an application represented in the visual representation of the network traffic information;
code for determining a portion of the network traffic information corresponding to the selected application; and
code for generating information configured for displaying one or more user interfaces that enable a user to interact with the determined portion of the network traffic information corresponding to the selected application.

33. The computer-readable storage medium of claim 18 further comprising:
code for receiving search criteria; and
code for generating another visual representation of the network traffic information based on each category in the plurality of categories that satisfy the search criteria.

34. The computer-readable storage medium of claim 18 further comprising:
code for receiving filter criteria; and
code for generating another visual representation of the network traffic information based on each category in the plurality of categories that satisfy the filter criteria.

35. A system for creating visualizations of network traffic, the system comprising:
one or more network traffic management devices configured to analyze network traffic associated with one or more communications networks; and
one or more visualization devices configured to:
receive a plurality of categories for applications associated with network traffic;
receive network traffic information from the one or more network monitoring devices;
determine a hierarchy of applications for each category in the plurality of categories based on applications represented in the network traffic information; and
generate a visual representation of the network traffic information based on each category in the plurality of categories
